(19) United States
(12) Patent Application Publication
(10) Pub. No.: US 2025/0045596 A1
(43) Pub. Date: Feb. 6, 2025

(54) LARGE LANGUAGE MODEL REGULATION SYSTEMS AND METHODS

(71) Applicant: INTUIT INC., Mountain View, CA (US)

(72) Inventors: Liran DREVAL, Tel Aviv (IL); Itay MARGOLIN, Tel Aviv (IL)

(73) Assignee: INTUIT INC., Mountain View, CA (US)

(21) Appl. No.: 18/362,508

(22) Filed: Jul. 31, 2023

(51) Int. Cl. G06N 3/096; G06N 3/045

(52) U.S. Cl. CPC G06N 3/096; G06N 3/045

(57) ABSTRACT

At least one processor may receive a query response generated by a query machine learning (ML) model, wherein the query response is generated in response to a query from a client device. The at least one processor may generate an evaluated likelihood of the query response being found in a training data set comprising known valid data, wherein the generating is performed using an evaluation ML model. The at least one processor may determine that the evaluated likelihood indicates the query response is likely to include valid data. In response to the determining, the at least one processor may return the query response to the client device.

### BACKGROUND

Many computer systems use large language models (LLMs) to perform various tasks. For example, user interfaces (UIs) can leverage LLMs to receive and respond to user input in a conversational manner. Many computer systems that employ LLMs integrate off-the-shelf LLM products and/or access LLM products provided and/or hosted by third parties.

Many LLMs, such as those in the off-the-shelf and third party examples, are not configured to be modified, but can only be manipulated by carefully writing prompts, a process known as “prompt engineering.” However, no amount of prompt engineering can fully guarantee that the LLM will always return useful or desirable responses to inputs. This problem is often referred to as the “alignment problem,” which is the challenge of ensuring an LLM operates in accordance with the intent of the LLM provider and/or user.

Because of the inaccessibility of LLM internal code, and because of the tendency of LLMs to “hallucinate” or otherwise provide undesirable results in some cases, LLMs present a technical problem of ensuring data quality that requires a technical solution.

### BRIEF DESCRIPTIONS OF THE DRAWINGS

FIG. 1A shows an example of a regulated large language model system according to some embodiments of the disclosure.

FIG. 1B shows another example of a regulated large language model system according to some embodiments of the disclosure.

FIG. 2 shows an example process of interaction between a client and the large language model system according to some embodiments of the disclosure.

FIG. 3 shows an example fact checker model training and/or configuration process according to some embodiments of the disclosure.

FIG. 4 shows an example foundational model training and/or configuration process according to some embodiments of the disclosure.

FIG. 5 shows an example output checking process according to some embodiments of the disclosure.

FIG. 6 shows a computing device according to some embodiments of the disclosure.

### DETAILED DESCRIPTION OF SEVERAL EMBODIMENTS

Systems and methods described herein can improve LLM reliability and/or response quality without modifying the fundamental structure of the LLM. The disclosed systems and methods provide a layer of protection configured to keep the LLM from doing harm. Generally, a risk of receiving unintended content from an LLM is always present. For example, fake news, falsified or offensive responses, or responses that don't comply with an organizational policy are all reasonably statistically likely responses to a query made to an LLM. To reduce this risk, the disclosed embodiments can fine tune an existing model with two objectives. First, the fine tuning can keep the model as close as possible to the original model (e.g., using the same weights as the original model). Second, the fine tuning can cause the LLM to produce an output with the lowest perplexity possible. An additional layer of processing beyond standard LLM processing can provide a “fact checker” feature that lowers the perplexity. This can improve the reliability of LLM responses, increasing LLM performance without requiring a change to the core operation of the LLM.

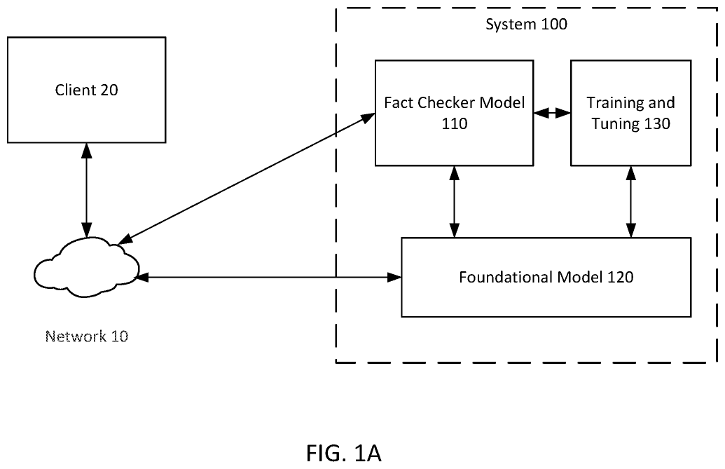

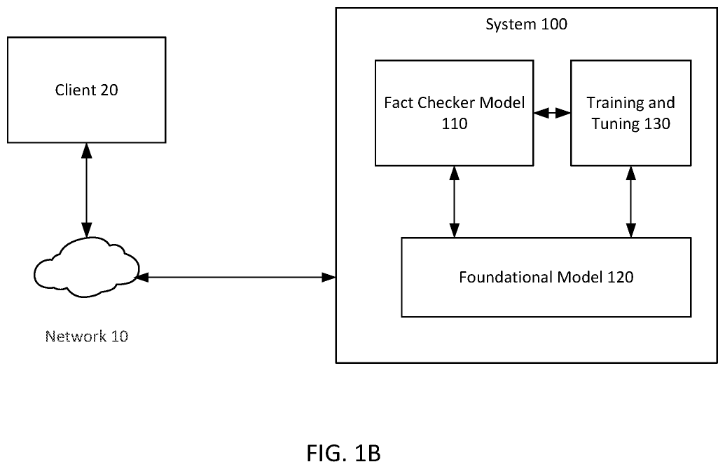

FIGS. 1A and 1B show examples of regulated LLM system 100 configurations according to some embodiments of the disclosure. System 100 may include a variety of hardware, firmware, and/or software components that interact with one another, such as fact checker model 110, foundational model 120, and/or training and tuning module 130. The operations of fact checker model 110, foundational model 120, and/or training and tuning module 130 are described in greater detail below, but in general, fact checker model 110 and foundational model 120 may be first and second machine learning (ML) models, such as LLMs, respectively performing processing operations on data (e.g., data received from client 20), and training and tuning module 130 may be configured to regulate the output of foundational model 120. For example, training and tuning module 130 may be configured to perform processing that ensures the output of foundational model 120 meets some standards for truth, policy compliance, or the like. Some components may communicate with one another and/or with client(s), such as client 20, through one or more networks 10 (e.g., the Internet, an intranet, and/or one or more networks that provide a cloud environment). For example, as described in detail below, client 20 can display a UI with elements provided by foundational model 120, and foundational model 120 can obtain data from a user of client 20 via interactions through the UI.

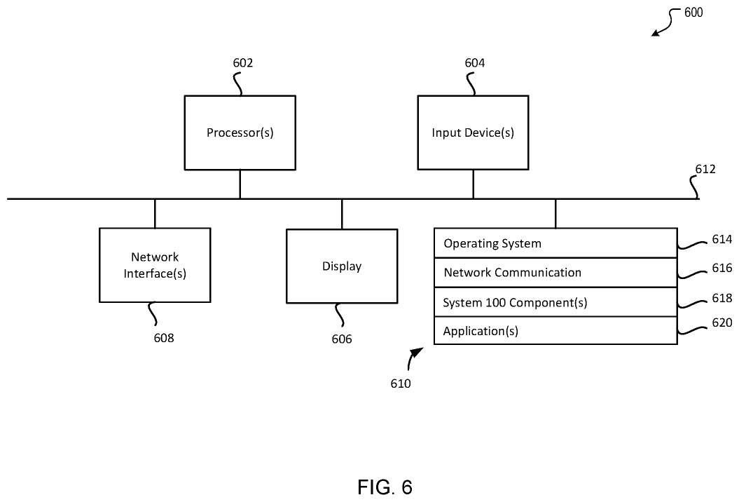

In some embodiments, such as the example of FIG. 1A, system 100 components can be provided by separate computing devices communicating with one another through network 10. For example, fact checker model 110, foundational model 120, and/or training and tuning module 130 may be respectively provided within different computing environments connected by network 10 (e.g., LLMs may be provided by a dedicated LLM service, such that respective models may be provided separately from one another and/or from training and tuning module 130). In other embodiments, such as that of FIG. 1B, fact checker model 110, foundational model 120, and/or training and tuning module 130 may be part of the same computing environment. Other combinations of computing environment configurations may be possible. Each component may be implemented by one or more computers (e.g., as described below with respect to FIG. 6).

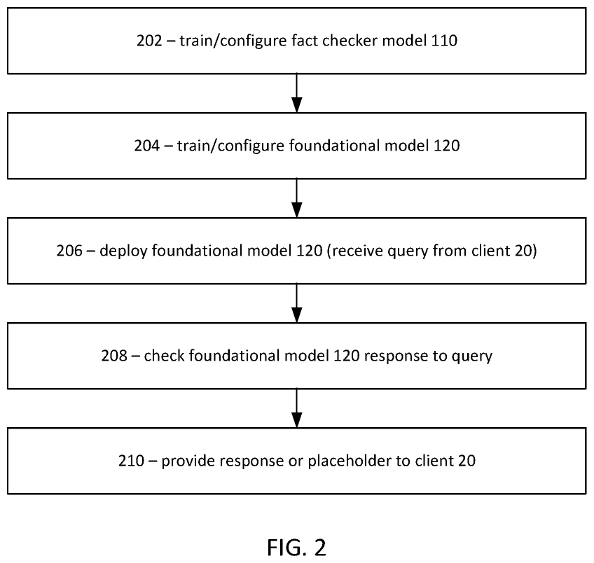

As described in detail below, system 100 can use foundational model 120 to communicate with a user of client 20. Furthermore, system 100 may include features that improve and/or maintain consistency of foundational model 120 operation. In particular, fact checker model 110 and training and tuning module 130 may perform processing that improves the quality, accuracy, and/or compliance of foundational model 120 outputs, even without retraining foundational model 120 and/or without fundamentally altering the algorithmic and/or structural configuration of foundational model 120. For example, FIGS. 2-5 illustrate the functioning of the illustrated components in detail.

Elements illustrated in FIGS. 1A and 1B (e.g., system 100 including fact checker model 110, foundational model 120, and/or training and tuning module 130), network 10, and/or client 20) are each depicted as single blocks for ease of illustration, but those of ordinary skill in the art will appreciate that these may be embodied in different forms for different implementations. For example, while fact checker model 110, foundational model 120, and training and tuning module 130 are depicted separately, any combination of these elements may be part of a combined hardware, firmware, and/or software element. Likewise, while fact checker model 110, foundational model 120, and training and tuning module 130 are each depicted as parts of a single system 100, any combination of these elements may be distributed among multiple logical and/or physical locations. Indeed, the disclosed embodiments provide improvements to distributed computing arrangements. Moreover, FIGS. 1A and 1B each show a single instance of fact checker model 110, foundational model 120, and training and tuning module 130 for ease of explanation of certain operations. However, varying numbers of instances of fact checker model 110, foundational model 120, and/or training and tuning module 130 may be possible in various embodiments. Also, while one network 10, one client 20, and one system 100 are illustrated, this is for clarity only, and multiples of any of the above elements may be present. In practice, there may be single instances or multiples of any of the illustrated elements, and/or these elements may be combined or co-located.

FIG. 2 shows an example process 200 of interaction between client 20 and system 100 according to some embodiments of the disclosure. Process 200 is an example of how fact checker model 110 and foundational model 120 may be configured and, thereafter, a user of client 20 can have a conversation with foundational model 120 of system 100 with responses by foundational model 120 being improved by system 100. This example is provided to give context for the following descriptions of the inner functioning of these and other system 100 elements.

At 202, system 100 can train and/or configure fact checker model 110. Fact checker model 110 may be trained and/or configured as an evaluation model to determine a likelihood of input data being found in a training data set comprising known valid data. For example, training and tuning module 130 can provide a set of known valid training data, such as data that has been evaluated by humans for truthfulness, internal data from an organization that is known or presumed true or valid relative to the organization's policies, etc. The training set can be significantly smaller than a training set used to train a full-featured LLM. Fact checker model 110 may be trained using this data set (referred to herein as data set “X”).

With fact checker model 110 trained, training and tuning module 130 can configured fact checker model 110 to detect how likely it is that a given data entry such as a text sample is found in X (referred to herein as likelihood “M”). For example, M(text) can be high if “text” complies with the training set X, and M(text) can be low if “text” does not comply with the training set X.

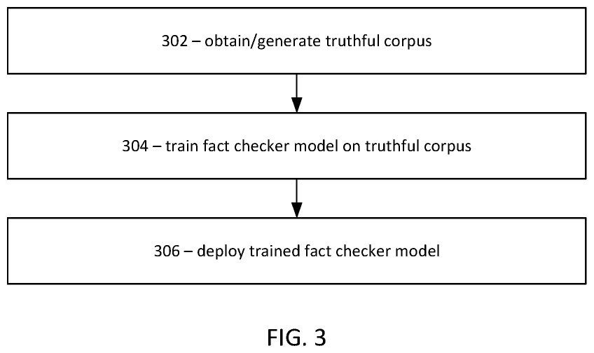

A detailed example of the training and/or configuration of fact checker model 110 is given below with reference to FIG. 3.

At 204, system 100 can train and/or configure foundational model 120 to function as a query model with a final loss function that is a function of the likelihood of input data being found in a training data set comprising known valid data as determined by fact checker model 110. Foundational model 120 can be a general-purpose LLM (e.g., Chat GPT, LLAMA, FALCON, etc.) or other off-the-shelf LLM. Foundational model 120 may be powerful and trained on a very large data corpus, but may be difficult or impossible to alter (e.g., due to being hosted by a third party or otherwise made inaccessible by its developer or vendor), aside from tuning parameters, prompt engineering, and/or other “external” alterations. However, by tuning parameters based on processing by fact checker model 110, training and tuning module 130 can configured foundational model 120 (as configured, referred to herein as “F”) such that its capabilities for generating responses are similar to those of the original foundational model 120 before tuning, and M(F(prompt)) will be high, indicating good compliance with training set X.

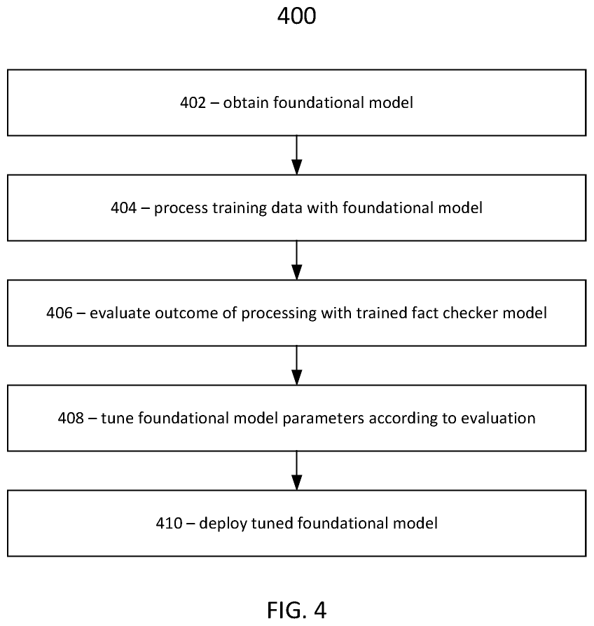

A detailed example of the training and/or configuration of foundational model 120 is given below with reference to FIG. 4.

At 206, system 100 can deploy foundational model 120 as configured at 204. For example, system 100 can present a UI including output of foundational model 120 to the user. For example, foundational model 120 output can be integrated into a UI of a broader system (e.g., a tax return preparation application or any other application). Inputs made into the foundational model 120 output UI element (e.g., free-form text into a text field) may also be collected by the foundational model 120. For example, system 100 may send data to client 20, through network 10, causing display of the UI on a display element of client 20. An input device of client 20 may capture input made by a user and send the input to system 100 through network 10.

In some embodiments, integration of the foundational model 120 output into a UI presented using client 20 may include the following. Client 20 may be in communication with system 100 through network 10, and system 100 may create a session specific to the current user interaction being facilitated by client 20. Creating the session may include creating a cookie. Client 20 can store the cookie in its local browser. System 100 may expose an unauthenticated end point of foundational model 120 that can take raw user input and return a raw text output. The cookie value from the session can be used for further conversations, and all calls to foundational model 120 for the conversation in question can be sandboxed in this manner.

During the session, context can be tracked and updated by system 100, so that as the foundational model 120 is invoked moving forward, the current state of the conversation can persist. The session can have a timeout time or period, after which system 100 can close the chat, thereby preventing too many active connections with foundational model 120.

During the session, a user of client 20 can input data into a field or otherwise enter data into the UI. Foundational model 120 can process the input from the user and generate a response.

At 208, system 100 can check the response generated by foundational model 120 at 206. For example, the query response can be generated by the configured foundational model 120, wherein the query response is generated in response to a query from client 20. System 100 (e.g., by the trained fact checker model 110) can then generate an evaluated likelihood of the query response being found in the training data set. For example, fact checker model 110, that has been prepared at 202, can process the response to determine whether M(F(response)) is above a threshold level for compliance. Thus, system 100 can determine whether the evaluated likelihood indicates the query response is likely to include valid data.

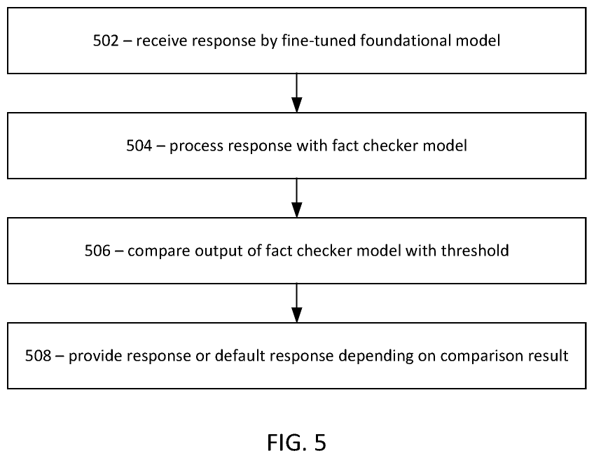

A detailed example of checking a response is given below with reference to FIG. 5.

At 210, system 100 can provide a response to client 20. For example, if the check at 208 indicates the response from foundational model 120 is compliant, system 100 may allow the response to be displayed in the UI on client 20. However, if the check at 208 indicates the response from foundational model 120 is not compliant, system 100 can return a placeholder or default response, such as a response indicating the LLM was unable to provide an accurate or compliant answer, or “I can't answer that question,” or similar.

FIG. 3 shows an example fact checker model 110 training and/or configuration process 300 according to some embodiments of the disclosure. For example, system 100 may perform process 300 as part of process 200 (e.g., at 202) to prepare fact checker model 110 for use in checking responses from foundational model 120.

At 302, system 100 can obtain and/or generate a truthful corpus of data to serve as known valid training data. The known valid training data can be verified manually for veracity or other standards of suitability, can be manually curated, and can therefore be assumed to be true for the purposes of process 200 described above. As noted above, the corpus of known valid training data need not be large compared to a training data set for a general-purpose LLM. For example, the corpus of known valid training data can be one or two orders of magnitude, or more, smaller than a training data set for a general purpose LLM (e.g., general purpose LLMs may be trained on ˜1 trillion tokens, whereas the corpus of known valid training data may include ˜1 million tokens).

At 304, system 100 (e.g., training and tuning module 130) can train fact checker model 110 using the truthful corpus of data serving as known valid training data. Fact checker model 110 can be a perplexity model, which may be a proprietary or off-the-shelf perplexity model configured to calculate perplexity relative to the known valid training data. Once trained, fact checker model 110 can return the likelihood of an input thereto to exist in the text of the known valid training data (calculating a perplexity measurement, for example).

At 306, system 100 can deploy the trained fact checker model 110. For example, system 100 can use trained fact checker model 110 to perform processing at 204 and/or 208 of process 200 as described above.

In some embodiments, alternative approaches to configuring the fact checker model 110 may be used. For example, system 100 can use a pre-trained off-the-shelf perplexity model without internally assembling or obtaining the truthful corpus of data using system 100 itself. As another example, system 100 can use a vector store as a fact checker model 110. In the vector store example, data obtained and/or generated at 302 can be a set of vectors encoding known truthful data. In this case, model training at 304 may not be necessary and, instead, system 100 can compare outputs of foundational model 120 with vectors to identify similarities, as described in detail below.

FIG. 4 shows an example foundational model 120 training and/or configuration process 400 according to some embodiments of the disclosure. For example, system 100 may perform process 400 as part of process 200 (e.g., at 204) to prepare foundational model 120 to provide accurate query responses.

At 402, system 100 can obtain a foundational model. For example, a pre-trained foundational model may be downloaded from a provider or vendor, and/or a remotely-hosted instance of a pre-trained foundational model may be instantiated. In some embodiments, system 100 (e.g., training and tuning module 130 and/or foundational model 120) can perform the pre-training, for example by using a large, general purpose corpus of data to train an LLM in a manner known to those of ordinary skill in the art.

At 404, system 100 (e.g., training and tuning module 130 and/or foundational model 120) can perform a training process including processing training data using foundational model 120 as obtained at 402. For example, the training data can include test data which may comprise one or more queries for foundational model 120 having known answers. For example, each query can have known correct answer(s) and/or known false answer(s). Foundational model 120 may take the training data as input and provide response(s) to the queries according to its algorithm, trained configuration, and parameters.

At 406, system 100 (e.g., training and tuning module 130 and/or fact checker model 110) can evaluate the outcome of the processing by foundational model 120 at 404. For example, fact checker model 110 can score M(F(response)) for each response generated by foundational model 120 at 404. Higher scores for M may indicate probable truth of the responses by foundational model 120 (i.e., low perplexity relative to the known truthful data). Lower scores for M may indicate that the responses by foundational model 120 are less likely to be true (i.e., high perplexity relative to the known truthful data). This may be the case even if the specific queries and/or responses are not part of the known truthful data.

At 408, system 110 (e.g., training and tuning module 130) can tune parameters of foundational model 120 according to the results of the evaluation at 406. While any pre-trained foundational model 120 obtained at 402 can have its own proprietary and, in many cases, secret algorithm(s) for generating responses, pre-trained foundational model 120 can also provide for some degree of customization. For example, foundational model 120 may be pre-configured with one or more weighted parameters. Varying the weights can affect how foundational model 120 responds to queries.

Accordingly, training and tuning module 130 can configure at least two loss functions for foundational model 120 and adjust the parameters according to these loss functions. These may include a first intermediate loss function configurable to minimize with an increase in similarity of output between the trained second ML model and the pre-trained foundational model and a second intermediate loss function configurable to minimize with an increase in the likelihood as determined by the first ML model.

For example, a first loss function (“Loss1”) can be as follows:

Loss1=sum(Ffine_tuned(params)−Foriginal(params))

where fine_tuned (params) indicates the parameters after adjustment by training and tuning module 130, and original (params) indicates the default parameters as set when foundational model 120 was obtained at 402.

A second loss function (“Loss2”) can be as follows:

Loss2=log(1−M(Ffine_tuned(input_text)))

A final loss function, therefore, may be given as follows:

Final Loss=(1−gamma)*(Loss1)+(gamma*Loss2)

where gamma is a hyperparameter (e.g., ranging from 0-1).

Through this tuning, training and tuning module 130 can configure foundational model 120 to balance the goals of maintaining good fidelity to the original foundational model 120 as obtained at 402 while at the same time improving the ability for foundational model 120 to provide truthful answers. As such, gamma may be selected to prioritize fidelity by minimizing Loss1, to prioritize truth by minimizing Loss2, or to give a more even balance between the two losses (e.g., setting gamma to 0.5 as a default parameter that can then be adjusted to prioritize desired features). Prioritizing Loss1 can allow foundational model 120 to provide more varied responses to queries at the expense of truth, while prioritizing Loss2 can allow foundational model 120 to be more trustworthy but more predictable in its responses.

At 410, system 100 can deploy the tuned foundational model 120. For example, system 100 can use tuned foundational model 120 to perform processing at 206 of process 200 as described above.

FIG. 5 shows an example output checking process 500 according to some embodiments of the disclosure. For example, system 100 may perform process 500 as part of process 200 (e.g., at 208) to evaluate responses by foundational model 120 for truth and/or policy compliance.

At 502, system 100 (e.g., training and tuning module 130 and/or fact checker model 110) can receive a response to a query from client 20 generated by foundational model 120 (e.g., as tuned by process 400).

At 504, system 100 can process the response from 502 using fact checker model 110. For example, fact checker model 110 may take the response as input and return M(F(input_text)) as described above.

At 506, system 100 can compare M(F(input_text)) as generated at 504 with a threshold (“h”). The threshold value may be selected as desired to produce results that are deemed acceptable for the use case of system 100. For example, system 100 can be tested prior to deployment to determine frequencies of returning unacceptably perplex results for given values of h, and h may be subsequently selected to have the value of a threshold that produced acceptable results during the test.

At 508, system 100 can provide the response from 502 or a default response to client 20 depending on the result of the comparison at 506. For example, if M(F(input_text))>h, system 100 can present output text from foundational model 120 as received at 502 to the user through a UI of client 20. Otherwise, system 100 can cause UI of client 20 to display a placeholder response, which may be indicative of the fact that the response by foundational model 120 cannot be verified and/or is out of compliance, for example.

As described above, system 100 can improve the performance of an LLM without fundamentally altering the LLM's algorithm. Through a combination of two ideas in generative models, the ordinary language model and the generative adversarial network. to some extent, foundational model 120 is “fooled” into providing generated text that is “realistic.” The disclosed embodiments can improve the reliability of LLM responses, increasing LLM performance without requiring a change to the core operation of the LLM.

FIG. 6 shows a computing device 600 according to some embodiments of the disclosure. For example, computing device 600 may function as a single system 100 or any portion(s) thereof, or multiple computing devices 600 may function as a system 100.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include the system elements and/or the instructions that enable computing device 600 to perform functions of system 100 as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method comprising:
training, by at least one processor, a first machine learning (ML) model to determine a likelihood of input data being found in a training data set comprising known truthful data;
configuring, by the at least one processor, a large language model (LLM) to produce outputs dependent upon a final loss function that is a function of the likelihood as determined by the first ML model, the configuring comprising:
configuring a first intermediate loss function of the LLM to minimize with an increase in similarity of output between the LLM and a pre-trained foundational model instance of the LLM,
configuring a second intermediate loss function of the LLM to minimize with an increase of the likelihood as determined by the first ML model,
configuring the final loss function to be a function of the first intermediate loss function and the second intermediate loss function, and
configuring the LLM to produce outputs that differ from outputs of the pre-trained foundational model due to application of the final loss function;
generating a plurality of query responses by the configured LLM, wherein each query response is generated in response to a respective query to the LLM from a user interface provided through a client device;
receiving, by the at least one processor, the plurality of query responses;
for each of the plurality of query responses, receiving, by the at least one processor, an evaluated likelihood of the query response being found in the training data set, wherein the evaluated likelihood is generated by the trained first ML model and using the query response as an input to the trained first ML model;
for at least a first query response of the query responses:
determining, by the at least one processor, that the evaluated likelihood indicates the first query response is likely to include truthful data, and
in response to the determining, returning, by the at least one processor, the first query response to the client device; and
for at least a second query response of the query responses:
determining, by the at least one processor, that the evaluated likelihood indicates the second query response is unlikely to include truthful data, and
in response to the determining, blocking, by the at least one processor, the second query response from being returned to the client device and returning a default response in place of the second query response to the client device.

2. The method of claim 1, wherein the trained first ML model is a perplexity model and the likelihood comprises a perplexity measurement.

3. (canceled)

4. (canceled)

5. (canceled)

6. The method of claim 1, wherein the determining that the evaluated likelihood indicates the first query response is likely to include truthful data comprises determining that the evaluated likelihood is greater than a threshold likelihood.

7. A method comprising:
training, by at least one processor, a first machine learning (ML) model to determine a likelihood of input data being found in a training data set comprising known truthful data;
configuring, by the at least one processor, a large language model (LLM) to produce outputs dependent upon a final loss function that is a function of the likelihood as determined by the first ML model, the configuring comprising:
configuring a first intermediate loss function of the LLM to minimize with an increase in similarity of output between the LLM and a pre-trained foundational model instance of the LLM,
configuring a second intermediate loss function of the LLM to minimize with an increase of the likelihood as determined by the first ML model,
configuring the final loss function to be a function of the first intermediate loss function and the second intermediate loss function, and
configuring the LLM to produce outputs that differ from outputs of the pre-trained foundational model due to application of the final loss function;
receiving, by the at least one processor, a plurality of queries to the LLM from a user interface provided through a client device;
for each of the plurality of queries, in response to the receiving, generating, by the at least one processor, a respective query response using the configured LLM;
generating, by the at least one processor, a respective evaluated likelihood of each respective query response being found in the training data set using the trained first ML model and using the query response as an input to the trained first ML model;
for at least a first query response;
determining, by the at least one processor, that the evaluated likelihood indicates the first query response is likely to include truthful data, and
in response to the determining, returning, by the at least one processor, the first query response to the client device; and
for at least a second query response:
determining, by the at least one processor, that the evaluated likelihood indicates the second query response is unlikely to include truthful data, and
in response to the determining, blocking, by the at least one processor, the second query response from being returned to the client device and returning a default response in place of the second query response to the client device.

8. The method of claim 7, wherein the trained first ML model is a perplexity model and the likelihood comprises a perplexity measurement.

9. (canceled)

10. (canceled)

11. (canceled)

12. The method of claim 7, further comprising pre-training, by the at least one processor, a foundational model to generate the pre-trained foundational model.

13. The method of claim 7, wherein the determining that the evaluated likelihood indicates the first query response is likely to include truthful data comprises determining that the evaluated likelihood is greater than a threshold likelihood.

14. A method comprising:
receiving, by at least one processor, a plurality of query responses generated by a large language model (LLM), wherein each query response is generated in response to a respective query to the LLM from a user interface provided through a client device;
for each of the plurality of query responses, generating, by the at least one processor, an evaluated likelihood of the respective query response being found in a training data set comprising known truthful data, wherein the generating is performed using an evaluation machine learning (ML) model using the respective query response as an input to the evaluation ML model, wherein the LLM is configured to produce outputs dependent upon a final loss function that is a function of the likelihood as determined by the first ML model according to the following configuration:
a first intermediate loss function of the LLM is configured to minimize with an increase in similarity of output between the LLM and a pre-trained foundational model instance of the LLM,
a second intermediate loss function of the LLM is configured to minimize with an increase of the likelihood as determined by the first ML model,
the final loss function is configured to be a function of the first intermediate loss function and the second intermediate loss function, and
the LLM is configured to produce outputs that differ from outputs of the pre-trained foundational model due to application of the final loss function;
for at least a first query response of the query responses:
determining, by the at least one processor, that the evaluated likelihood indicates the first query response is likely to include truthful data, and
in response to the determining, returning, by the at least one processor, the first query response to the client device; and
for at least a second query response of the query responses:
determining, by the at least one processor, that the evaluated likelihood indicates the second query response is unlikely to include truthful data, and
in response to the determining, blocking, by the at least one processor, the second query response from being returned to the client device and returning a default response in place of the second query response to the client device.

15. The method of claim 14, wherein the evaluation ML model is a perplexity model and the likelihood comprises a perplexity measurement.

16. The method of claim 15, further comprising training, by the at least one processor, the evaluation ML model on the training data set.

17. (canceled)

18. (canceled)

19. (canceled)

20. The method of claim 14, wherein the determining that the evaluated likelihood indicates the first query response is likely to include truthful data comprises determining that the evaluated likelihood is greater than a threshold likelihood.

21. (canceled)

22. (canceled)

23. (canceled)

24. The method of claim 1, wherein the determining that the evaluated likelihood indicates the second query response is unlikely to include truthful data comprises determining that the evaluated likelihood is less than a threshold likelihood.

25. The method of claim 1, wherein the LLM is configured to be internally unmodifiable by the at least one processor.

26. The method of claim 7, wherein the determining that the evaluated likelihood indicates the second query response is unlikely to include truthful data comprises determining that the evaluated likelihood is less than a threshold likelihood.

27. The method of claim 7, wherein the LLM is configured to be internally unmodifiable by the at least one processor.

28. The method of claim 14, wherein the determining that the evaluated likelihood indicates the second query response is unlikely to include truthful data comprises determining that the evaluated likelihood is less than a threshold likelihood.

29. The method of claim 14, wherein the LLM is configured to be internally unmodifiable by the at least one processor.

16. The method of claim 15, further comprising training, by the at least one processor, the evaluation ML model on the training data set.

17. (canceled)

18. (canceled)

19. (canceled)

20. The method of claim 14, wherein the determining that the evaluated likelihood indicates the first query response is likely to include truthful data comprises determining that the evaluated likelihood is greater than a threshold likelihood.

21. (canceled)

22. (canceled)

23. (canceled)

24. The method of claim 1, wherein the determining that the evaluated likelihood indicates the second query response is unlikely to include truthful data comprises determining that the evaluated likelihood is less than a threshold likelihood.

25. The method of claim 1, wherein the LLM is configured to be internally unmodifiable by the at least one processor.

26. The method of claim 7, wherein the determining that the evaluated likelihood indicates the second query response is unlikely to include truthful data comprises determining that the evaluated likelihood is less than a threshold likelihood.

27. The method of claim 7, wherein the LLM is configured to be internally unmodifiable by the at least one processor.

28. The method of claim 14, wherein the determining that the evaluated likelihood indicates the second query response is unlikely to include truthful data comprises determining that the evaluated likelihood is less than a threshold likelihood.

29. The method of claim 14, wherein the LLM is configured to be internally unmodifiable by the at least one processor.
